(19) United States
(12) Patent Application Publication
(10) Pub. No.: US 2004/0031886 A1
(43) Pub. Date: Feb. 19, 2004

(54) Barrier pass-through connector for cable support system and method of installing the same

(76) Inventor: Roger Jette, West Islip, NY (US)

Correspondence Address: Raymond E. Farrell, Carter, DeLuca, Farrell & Schmidt, LLP, Suite 225, 445 Broad Hollow Road, Melville, NY, 11747, US

(21) Appl. No.: 10/219,178

(22) Filed: Aug. 15, 2002

(51) Int. Cl. F16L 3/00

(52) U.S. Cl. 248/49

(57) ABSTRACT

The present disclosure provides for pass-through connectors for passing a run of cables through a barrier, from a first portion of a cable management system disposed on a first side of the barrier to a second portion of a cable management system disposed on a second side of the barrier. A pass-through connector includes a pass-through body portion configured and adapted to support the run of cables through an opening formed in the barrier and an electrical ground bond conductor secured to the pass-through body portion. The electrical ground bond conductor includes first and second extended portions adapted for electrical connection to a cable management system such that an electrical ground bond connection is established between two sections of the cable management section joined by the electrical ground bond conductor.

### BACKGROUND

1. Technical Field

The present disclosure relates to cable support management systems and, more particularly, to pass-through or linkage connectors for mounting a cable support management system relative to a barrier.

2. Background of Related Art

With the increasing volume of telecommunication and data cables being incorporated into buildings, cable management systems are becoming more and more critical. Previous cable management systems utilized rigid box trays or ladders which required a high degree of labor and components to perform even a simple installation. The amount of labor and additional components significantly increased when attempting an installation which required routing of the cable tray around obstacles such as ductwork, plumbing, columns, beams, ceiling/floor joists, walls and the like.

Accordingly, in my earlier patents, namely, U.S. Pat. No. 5,839,702, issued Nov. 24, 1998; U.S. Pat. No. 6,019,323, issued Feb. 1, 2000; U.S. Pat. No. 6,361,000, issued Mar. 26, 2002, the entire contents of which are hereby incorporated by reference, there is disclosed a flexible cable management system which greatly simplified the installation, organization, routing and protection of cable over, under and around obstacles present in an installation site. In short, the cable management systems disclosed therein are designed to bend into curves in either a lateral or a vertical direction without a number of tools or fixtures in order to navigate around any obstacle. As disclosed in these earlier patents, the cable support apparatus includes a plurality of cable support members interconnected by an elongate flexible spine member which is selectively bendable into a number of different configurations.

In my additional patents, namely, U.S. Pat. No. 5,953,870, issued Sep. 21, 1999; and U.S. Pat. No. 6,347,493, issued Feb. 19, 2002, the entire disclosures of which are hereby incorporated by reference, there are disclosed raised floor cable support systems and apparatus. In short, the raised floor systems disclosed therein include, inter alia, a cable support channel section depending from a pair of stringer elements, which stringer elements are each supported by a pair of stanchions, the stringer elements being configured and adapted to support a floor tile of the raised floor system thereon.

While the cable management systems disclosed in my earlier patents effectively and efficiently navigate a run of cable wires around, over and under a number of obstacles, there is a need for a cable management system which is capable of navigating a run of cables through a barrier which can not easily and efficiently be gone around, over or under, such as, for example, a fire wall, bulkhead, etc.

### SUMMARY

The present disclosure provides for pass-through connectors for passing a run of cables through a barrier, from a first portion of a cable management system disposed on a first side of the barrier to a second portion of a cable management system disposed on a second side of the barrier. A pass-through connector includes a pass-through body portion configured and adapted to support the run of cables through an opening formed in the barrier and an electrical ground bond conductor secured to the pass-through body portion. The electrical ground bond conductor includes first and second extended portions adapted for electrical connection to a cable management system such that an electrical ground bond connection is established between two sections of the cable management system joined by the electrical ground bond conductor.

In one aspect of the present disclosure the pass-through body portion includes a tubular body having a proximal end and a distal end wherein the tubular body defines a lumen therethrough. The electrical ground bond conductor preferably includes a shaft portion electrically interconnecting the first and second extended portions to one another. Preferably, a distal end of each of the first and second extended portions is offset a radial distance away from an outer surface of the tubular body. The distal end of each of the first and second extended portions preferably extends radially away from the tubular body a distance such that the lumen of the tubular body is substantially aligned with a cable passage defined by the cable management system. Preferably, the tubular body and each of the first and second extended portions are made from an electrically conductive material. Accordingly, an electrical path is established between the first and second extended portions.

The pass-through connector further includes a connector bolt for electrically coupling a portion of the cable management system to each of the first and second extended portions of the pass-through connector. The connector bolt includes a threaded split body portion configured and sized to receive either the first and second extended portions and an end of the cable management system therein, a dividing element disposed within the split body portion to separate the first and second extended portions from the end of the cable management system, and a nut threadably couplable to the split body portion for securing the first and second extended portions to the end of the cable management system. Preferably, the dividing element maintains an electrical connection between the first or second extended portions and the end of the cable management system.

The pass-through connector further includes a fire stop collar assembly configured and adapted to surround the tubular body at least on one side of the barrier and to prevent the passage of fire through the barrier between a gap defined by the barrier and an outer surface of the tubular body. Preferably, the fire stop collar assembly includes an intumescing substance which expands upon exposure to elevated temperatures to thereby seal the gap between the barrier and the tubular body. In one aspect of the present disclosure the tubular body is filled with an intumescing substance which expands upon exposure to elevated temperatures to thereby seal the lumen of the tubular body at elevated temperatures.

In another aspect of the present disclosure the pass-through body portion is configured and adapted to be disposed in a gap defined by an upper and a lower barrier. The pass-through body portion includes a mounting plate configured and adapted to be secured to the upper barrier and an electrical conduit secured to the mounting plate and an electrical ground bond conductor secured thereto. The ground bond conductor includes first and second extended portions extending substantially orthogonally from opposite sides of the mounting plate and a shaft portion electrically interconnecting the first and second extended portions. The mounting plate includes a pair of upstanding sidewalls extending from the opposite sides of the mounting plate.

Preferably, the mounting plate and each of the first and second extended portions are made from an electrically conductive material, wherein an electrical path is established between the first and second extended portions.

The mounting plate preferably includes at least one retaining clip affixed to a lower surface of the mounting plate. The at least one retaining clip is adapted to support a plurality of cables, being carried by the cable management system, over a wider area in order to reduce a height of the plurality of cables. In one aspect of the disclosure each retaining clip includes a first leg which is affixed to the lower surface of the mounting plate and a second leg which is spaced a distance from the lower surface of the mounting plate in order to define a space through which cables can be fed into the retaining clips.

The present disclosure also provides for a method of installing a pass-through connector for a cable management system on a barrier. The method includes the steps of providing a pass-through connector including a body portion configured and adapted to support the run of cables through an opening formed in the barrier and an electrical ground bond conductor secured thereto, electrically connecting the pass-through connector to first and second portions of a cable management system.

Preferably, according to one aspect of the method, the pass-through connector includes a tubular body having a proximal end and a distal end, the tubular body defining a lumen therethrough. The ground bond conductor includes a first and a second extended portion extending axially from a respective proximal and distal end of the tubular body and a shaft portion electrically interconnecting the first and the second extended portions thereof.

The method further includes the steps of securing the pass-through connector to the barrier with a fire stop collar assembly, and introducing an intumescing substance into the gap, the intumescing substance expanding upon an exposure to elevated temperatures to thereby seal the gap between the barrier and the tubular body. The fire stop collar assembly is preferably configured and adapted to surround the tubular body at least on one side of the barrier and to prevent the passage of fire through the barrier between a gap formed in the barrier for passage of the tubular body and an outer surface of the tubular body.

In another aspect of the method the pass-through body portion is configured and adapted to be disposed in a gap between an upper and a lower barrier. The method further including the step of mounting the pass-through body portion to an opening formed in the barrier with a mounting plate configured and adapted to be secured to the barrier.

Other aspects and features of the present disclosure will become apparent from consideration of the following description taken in conjunction with the accompanying drawings.

### BRIEF DESCRIPTION OF THE DRAWINGS

The accompanying drawings, which are incorporated in and constitute a part of this specification, illustrate preferred embodiments, and together with the description, serve to explain the principles of the presently disclosed cable support system pass-through connector, wherein:

FIG. 1 is a perspective view of a pass-through connector, for interconnecting portions of a cable management system, in accordance with an illustrative embodiment of the present disclosure;

FIG. 2 is a perspective view of the pass-through connector of FIG. 1 in an exemplary environment illustrating the coupling and assembly to an exemplary cable management system;

FIG. 3 is an enlarged view of the area indicated by the numeral “3” in FIG. 2, illustrating the coupling of the pass-through connector of FIG. 1 to the exemplary cable management system;

FIG. 4 is a perspective view of a pass-through connector, for interconnecting portions of a cable management system, in accordance with an alternative illustrative embodiment of the present disclosure;

FIG. 5 is a side elevational view of the pass-through connector of FIG. 4;

FIG. 6 is a front elevational view of the pass-through connector of FIG. 4, shown in an exemplary embodiment; and

FIG. 7 is a bottom plan view of the pass-through connector of FIG. 4, shown in the exemplary embodiment of FIG. 6.

### DETAILED DESCRIPTION OF PREFERRED EMBODIMENTS

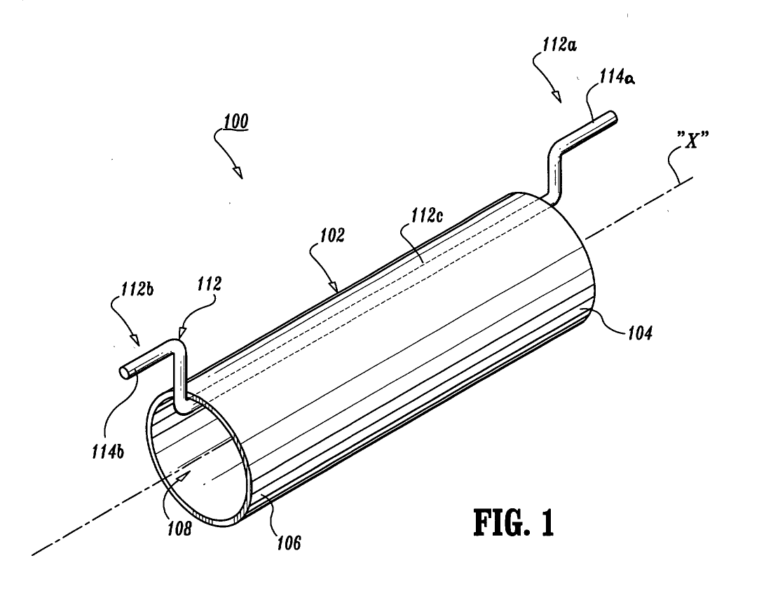

Referring now in specific detail to the drawings, in which like reference numerals identify similar or identical elements throughout the several views, and initially to FIGS. 1-3, one embodiment of a pass-through connector for use with a cable management system in shown generally as pass-through connector 100.

Pass-through connector 100 forms a ground bond between the connected cable tray sections. As seen in FIGS. 1-3, pass-through connector 100 includes a tubular body 102 having a proximal end 104, a distal end 106 and defines a passage 108 therethrough. Tubular body 102 can be fabricated from any number of materials, such as, for example, steel, including and not limited to galvanized, stainless, copper as well as from polyvinylchloride (PVC) and the like. In accordance with the present disclosure, tubular body 102 can have any length or diameter, however, tubular body 102 should have a length and a diameter specifically selected for the particular installation. For example, the diameter of tubular body 102 can be larger or smaller depending on whether more or fewer cables need to pass therethrough. Additionally, the length of tubular body 102 can be longer or shorter depending on the thickness of the barrier through which tubular body 102 is to pass. While a circular tubular body 102 is shown in the figures, it is contemplated that tubular body 102 can include a body portion having an elliptical, square, rectangular, or other polygonal cross-sections.

Pass-through connector 100 further includes an electrical ground bond connector element 112 secured thereto. Connector element 112 includes a first extended portion 112a extending from a proximal end 104 of tubular body 102, a second extended portion 112b extending from a distal end 106 of tubular body 102, and a shaft portion 112c electrically interconnecting first and second extended portions 112a, 112b. First and second extended portions 112a, 112b permit coupling of a respective cable management system thereto. First and second extended portions 112a, 112b, extend axially away from a central “X” axis of tubular body 102. Preferably, first and second extended portions 112a, 112b have a goose-neck like configuration such that a distal most end 114a, 114b, respectively, of each extended portion 112a, 112b extends a radial distance away from the outer surface of tubular body 102. Preferably, distal most ends 114a, 114b are oriented to be parallel with the central “X” axis of tubular body 102. In order to establish the ground bond between cable tray sections, connector element 112 is preferably fabricated from an electrically conductive material, such as, for example, wire stock.

In an alternative embodiment, it is envisioned that if tubular body 102 is fabricated from an electrically conductive material, extended portions 112a, 112b can be separate elements which are welded to proximal end 104 and distal end 106, respectively. In this manner, tubular body 102 can replace the function of shaft portion 112 to electrically interconnect first and second extended portions 112a, 112b to one another.

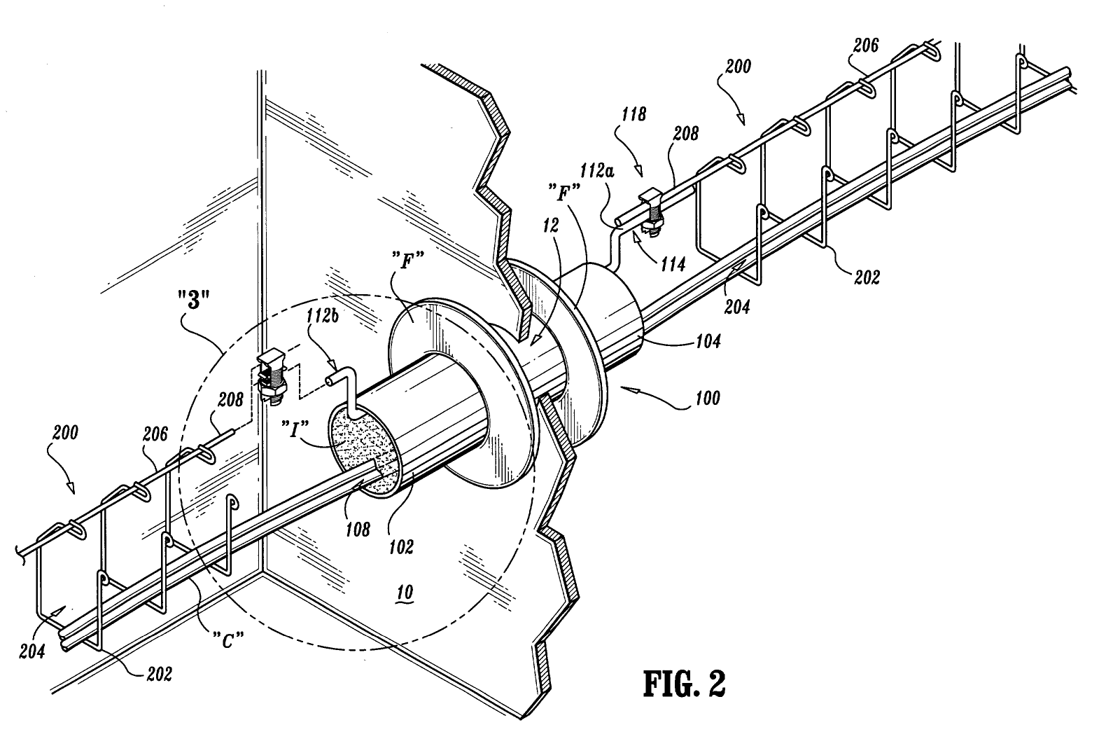

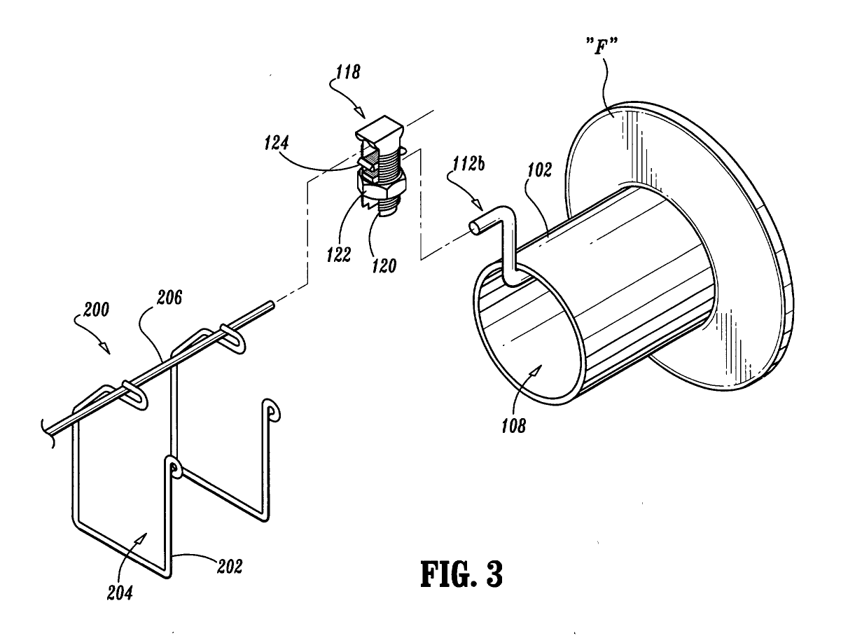

As best seen in FIGS. 2 and 3, pass-through connector 100 is shown in place extending through an exemplary barrier (i.e., a fire stop, wall, bulkhead, floor, ceiling, etc.). As described in detail with reference to FIG. 2, the exemplary barrier is preferably a fire stop wall 10 (i.e., a wall which extends completely from floor to ceiling and contacts adjacent walls along either side thereof, thereby leaving no gaps, spaces, channels or openings through the wall). As seen in FIG. 2, pass-through connector 100 proximal end 104 is shown already coupled to a portion of an exemplary cable management system 200 and distal end 106 being coupled to another portion of the exemplary cable management system 200. Cable management system 200 may be any type of available cable conveyance system. For example, the flexible cable support apparatus as disclosed in my earlier U.S. Pat. Nos. 6,019,323 and 6,361,000. Alternatively, cable management system 200 may be a rigid cable tray including, inter alia, a plurality of cable support members 202 defining a cable receiving portion 204 and a flexible spine member 206 transversely interconnecting the plurality of cable support members 202. Flexible spine member 206 preferably terminates in free distal and proximal ends 208. Cable support members 202 can include a series of trays, troughs, baskets, ladders and the like.

Pass-through connector 100 is preferably attached to or held in place in wall 10 by suitable mounting collars or the like, such as, for example, a fire stop collar assembly. A conventional fire stop collar assembly is typically wrapped around a pipe (either PVC or metal), adjacent to an opening in the wall (or floor or ceiling) through which the pipe passes and is provided with a quantity of intumescent material “I”. As such, if a fire breaks out in either one of the rooms with which the pipe communicates, the intumescent material within the fire stop collar assembly will begin to intumesce (i.e., expand) when the temperature reaches a certain level. The expansion of the intumescent material is directed radially inward due to the outer restraining layer of the fire stop collar assembly preventing/restricting outward radial expansion. As a result, the intumescing material closes off the opening in the barrier or wall and if the pipe is made from PVC the intumescing material crushes the PVC pipe, which is softened by the heat of the fire. A conventional fire stop collar assembly is disclosed in U.S. Pat. No. 4,951,442, to Harbeke, Jr., the entire contents of which are hereby incorporated by reference.

With reference to FIGS. 2 and 3, pass-through connector 100 is inserted through an aperture 12 formed in wall 10 and is preferably oriented such that first and second extended portions 112a, 112b are oriented above passage 108 of tubular body 102. Preferably, a fire stop collar assembly “F”, as described above, is coupled to either side of tubular body 102 such that each fire stop collar assembly “F” is in contact with a surface of wall 10. With pass-through connector 100 in place within wall 10, cable management system 200, as described above, can be securely coupled to a respective extended portion 112a, 112b by using a universal connector bolt 118, as seen in greater detail in FIG. 3.

Universal connector bolt 118 includes a threaded split body portion 120, a nut 122 and a dividing element 124 disposed within split body portion 120. Preferably, universal connector bolt 118 is fabricated from an electrically conductive material and thus completes both mechanical and electrical connections between pass-through connector 102 and cable management systems 200. In use, universal connector bolt 118 receives either a distal end 114a, 114b of a respective extended portion 112a, 112b and a free proximal or distal end 208 of cable management system 200. Distal ends 114a, 114b are separated from distal ends 208 of cable management system 200 by dividing element 124, within the split of body portion 120. Nut 122 is then threaded onto body portion 120 and tightened in order to secure distal end 114a, 114b of extended portions 112a, 112b and distal ends 208 of cable management systems 200 to one another. Since dividing element 124 is fabricated from an electrically conductive material, an electrical connection will remain between distal ends 114a, 114b of extended portions 112a, 112b and distal ends 208 of cable management system 200.

Preferably, as seen in FIG. 2, when pass-through connector 100 is coupled to cable management system 200, passage 108 of tubular body 102 is substantially axially aligned with a cable retaining channel defined by cable receiving portions 204 of cable management system 200. In this manner, cables “C”, running through pass-through connector 100 and onto cable management system 200, will experience a smooth transition.

It is contemplated that after pass-through connector 100 and cable management system 200 are installed through wall 10 at an installation site, passage 108 of tubular body 102 of pass-through connector 100 can be filled with an intumescent material or composition “I”, which intumescent material “I” expands to fill passage 108 of tubular body 102 in response to predetermined thermally elevated temperatures. For example, an intumescent material made of dipentaerythritol begins to intumesce at about 220° C., while an intumescent material made from an intercalated flake begins to intumesce at about 260° C., as disclosed in U.S. Pat. No. 5,498,466 to Navarro et al. It is envisioned that the intumescent material can be a powder, a foam, a batting or the like. It is contemplated that proximal and distal ends 104, 106 of tubular body 102 are sealed in order to prevent the escape of intumescent material “I” therefrom.

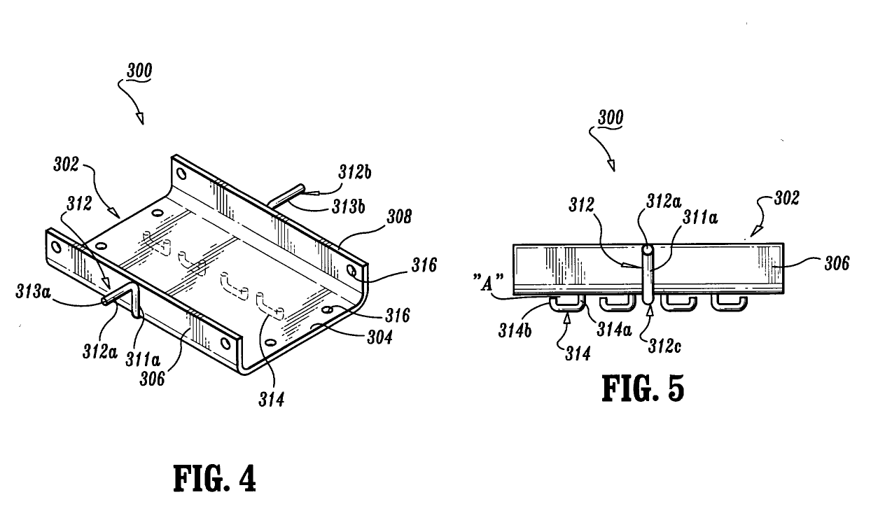

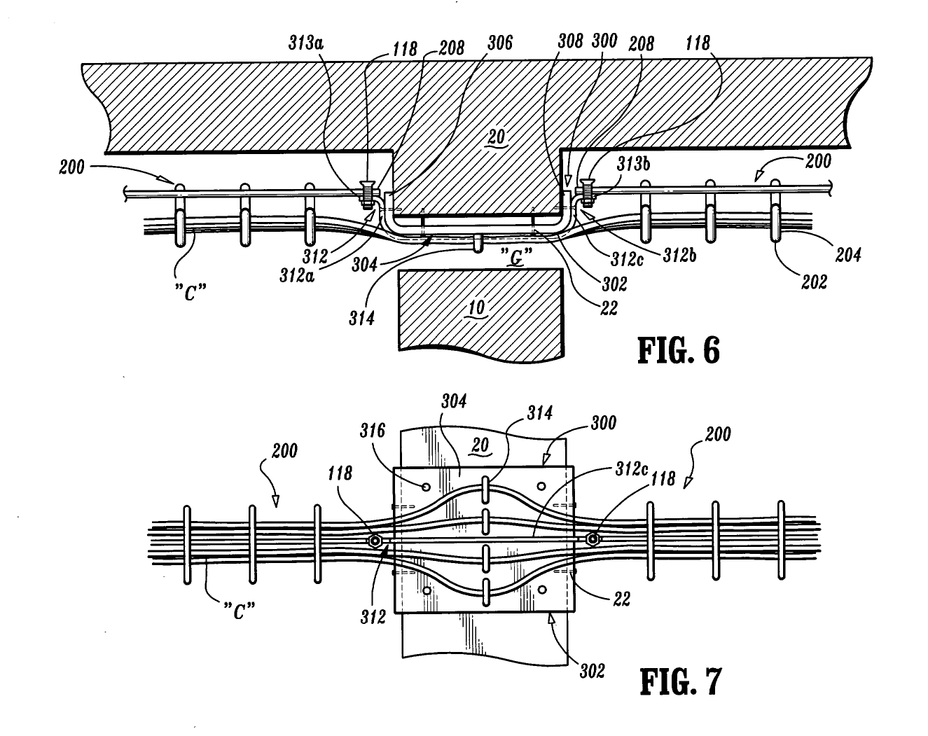

Turning now to FIGS. 4-7, a pass-through connector, in accordance with an alternative embodiment of the present disclosure, for passing through a barrier or obstruction, is shown generally as 300. Pass-through connector 300 includes a U-shaped mounting bracket 302 having a bottom wall 304 and a pair of upstanding sidewalls 306, 308 extending from either side of bottom wall 304. Preferably, bottom wall 304 of pass-through connector 300 has a width which is slightly wider than a width of the barrier to which it is to be mounted, as seen in FIGS. 6 and 7.

Pass-through connector 300 includes an electrical ground bond connector element 312 secured thereto. Connector element 312 includes a first extended portion 312a secured to sidewall 306, a second extended portion 312b secured to sidewall 308, and a shaft portion 312c extending across bottom wall 304 and electrically interconnecting first and second extended portions 312a, 312b to one another. Extended portions 312a, 312b are preferably fabricated from an electrically conductive material, such as, for example, steel, either stainless, galvanized of the like in order to transmit electrical current between adjacent portions of connected cable tray sections. U-shaped mounting bracket 302 includes a plurality of holes 316 formed in bottom wall 304, sidewalls 306, 308 and/or both for mounting pass-through connector 300 to the barrier.

Extended portions 312a, 312b preferably extend orthogonally away from sidewalls 306, 308. Preferably, each extended portion 312a, 312b is L-shaped and includes a leg portion 311a, 311b, affixed to a respective sidewall 306, 308 and an arm portion 313a, 313b which extends orthogonally away from side walls 306, 308. While L-shaped extended portions 312a, 312b have been disclosed, it is envisioned that extended portions 312a, 312b can take on any number of configurations, including but not limited to axial rods, goose-neck like elements, U-shaped elements, etc.

Pass-through connector 300 further includes a plurality of U-shaped retaining clips 314 secured to a bottom surface of bottom wall 304. As seen in FIG. 5, each U-shaped retaining clip 314 includes a first leg 314a which is secured to the bottom surface of bottom wall 304 and a second leg 314b which is spaced a distance from the bottom surface of bottom wall 304. Each U-shaped retaining clip 314 defines a cable retaining area “A”. While a plurality of U-shaped retaining clips 314 is preferred, it is envisioned that a single elongated clip (not shown), extending substantially the entire depth of mounting bracket 302, can be provided. Retaining clips 314 function to reduce the height of a single bundle of cables being carried by a cable management system preferably into a plurality of smaller bundles of cables carried by retaining clips 314 with each smaller bundle having a reduced height in order to pass through a narrow gap formed in the barrier.

It is envisioned that a cable management system 200, as described above, can be coupled to a respective extended portion 312a, 312b of pass-through connector 300 via a universal connector bolt 118, as described above. In particular, universal connector bolt 118 receives arm portion 313a, 313b of extended portions 312a, 312b and a free proximal or distal end 208 of cable management system 200. Arm portions 313a, 313b are separated from distal ends 208 of cable management system 200 by dividing element 124. Nut 122 is then threaded onto body portion 120 and tightened in order to secure arms 313a, 313b of extended portions 312a, 312b and distal ends 208 of cable management systems.

Alternatively, it is contemplated that pass-through connector 300 can include a U-shaped mounting bracket 302 made from an electrically conductive material and extended portions 312a, 312b can be welded to a respective sidewall 306, 308. Accordingly, since U-shaped mounting bracket 302 is electrically conductive a ground bond connection is established between a portion of cable management system 200, on one side of the barrier and a portion of cable management system 200 on the other side of the barrier.

While a U-shaped mounting bracket 302 is depicted and described it is envisioned that mounting bracket 302 can take on any number of configurations. For example, mounting bracket 302 can include a planar mounting plate (not shown) to which extended portions 312a, 312b and shaft portion 312c are securely affixed, wherein U-shaped retaining clips 314 are affixed to a surface of the mounting plate. Preferably, the planar mounting plate is provided with holes through which fasteners (i.e., screws) can pass in order to secure the mounting plate to the barrier. Moreover, while the figures depict a mounting bracket 302 having a bottom wall 304 having a width which is substantially equal to the width of the barrier, it is envisioned that mounting bracket 302 can have a planar mounting plate (not shown) having a width which is less than the width of the barrier.

In use, as seen in FIGS. 6 and 7, pass-through connector 300 is mounted, secured or otherwise fastened in place to the barrier. In particular, as depicted in FIGS. 6 and 7, the barrier includes a bulkhead or ceiling/floor joist 20 which overlies a wall 10 and defines a gap or space “G” therebetween. Accordingly, pass-through connector 300 is secured to bulkhead 20, within gap “G” such that U-shaped bracket 302 substantially wraps around bulkhead 20, via fasteners 22 (i.e., screws or the like) extending through holes 316 formed in U-shaped bracket 302 and into bulkhead 20. Portions of cable management systems 200 are then coupled to a respective extended portion 312a, 312b via universal connector bolts 118, as described above. Cables “C” can then be laid within cable receiving portions 204 of cable support members 202 of cable management system 200. Since gap “G” is of a finite height, the possibility exists that the bundle of cable “C” being carried by cable management systems 200, has a height which is larger that the height of gap “G”. Accordingly, the single bundle of cables “C”, being carried by cable management systems 200, can be separated, divided or fanned out into a multiplicity of smaller bundles made up of a plurality of cables “C” which are carried or retained within area “A” of retaining clips 314 in order to pass cables “C” through gap “G” between bulkhead 20 and wall 10.

It is further contemplated that, after cables “C” have been run through gap “G”, that an intumescent material or composition, which material expands to fill gap “G” in response to predetermined thermally elevated temperatures. It is envisioned that the intumescent material can be a powder, a foam, a batting or the like.

While the above disclosure of pass-through connectors 100, 300 were depicted and described in combination with a cable management system having a plurality of substantially “C-shaped” cable support members 202 and a flexible spine member 206 transversely interconnecting the plurality of cable support members 202, it is contemplated that any configuration of cable management systems can be utilized. For example, a cable management system having a plurality of substantially “M-shaped” spokes interconnected by a single flexible spine, as disclosed in my earlier U.S. Pat. No. 5,839,702, can be used in conjunction with pass-through connectors 100, 300 disclosed herein. It is further contemplated that the cable management system, used in conjunction with pass-through connectors 100, 300, can include a substantially “W-shaped” cable support member interconnected by a single flexible spine member as disclosed in my earlier U.S. Pat. No. 6,019,323.

Although the illustrative embodiments of the present disclosure have been described herein with reference to the accompanying drawings, it is to be understood that the disclosure is not limited to those precise embodiments, and that various other changes and modifications may be affected therein, by one skilled in the art, without departing from the scope or spirit of the disclosure. All such changes and modifications are intended to be included within the scope of the disclosure as defined by the appended claims.

What is claimed is:

1. A pass-through connector for passing a run of cables through a barrier, from a first portion of a cable management system disposed on a first side of the barrier to a second portion of a cable management system disposed on a second side of the barrier, wherein the pass-through connector comprises:
a pass-through body portion configured and adapted to support the run of cables through an opening formed in the barrier; and
an electrical ground bond connector secured to the pass-through body portion, the ground bond connector having first and second extended portions adapted for electrical connection to a cable management system such that an electrical ground bond connection is established between two sections of the cable management system joined by the electrical ground bond connector.

2. The pass-through connector according to claim 1, wherein the pass-through body portion includes a tubular body having a proximal end and a distal end, the tubular body defining a lumen therethrough.

3. The pass-through connector according to claim 2, wherein the electrical ground bond connector includes a shaft portion electrically interconnecting the first and second extended portions thereof.

4. The pass-through connector according to claim 3, wherein a distal end of each of the first and second extended portions is offset a radial distance away from an outer surface of the tubular body.

5. The pass-through connector according to claim 4, wherein the tubular body and each of the first and second extended portions are made from an electrically conductive material whereby an electrical path is established between the first extended portion and the second extended portion.

6. The pass-through connector according to claim 5, further comprising:
a connector bolt for electrically coupling a portion of the cable management system to each of the first and second extended portions of the pass-through connector.

7. The pass-through connector according to claim 6, further comprising:
a fire stop collar assembly configured and adapted to surround the tubular body at least on one side of the barrier and to prevent the passage of fire through the barrier between a gap defined by the barrier and an outer surface of the tubular body.

8. The pass-through connector according to claim 2, wherein the tubular body is filled with an intumescing substance which expands upon exposure to elevated temperatures to thereby seal the lumen of the tubular body at elevated temperatures.

9. The pass-through connector according to claim 2, wherein the fire stop collar assembly includes an intumescing substance which expands upon exposure to elevated temperatures to thereby seal the gap between the barrier and the tubular body.

10. The pass-through connector according to claim 9, wherein the distal end of each extended portion extends radially away from the tubular body a distance such that the lumen of the tubular body is substantially aligned with a cable passage defined by the cable management system.

11. The pass-through connector according to claim 1, wherein the pass-through body portion is configured and adapted to be disposed in a gap defined by an upper and a lower barrier, wherein the pass-through body portion includes a mounting plate configured and adapted to be secured to the upper barrier, and an electrical ground bond secured to the mounting plate and having first and second extended portion extending substantially orthogonally from opposite sides of the mounting plate and a shaft portion electrically interconnecting the first and second extended portions.

12. The pass-through connector according to claim 11, wherein the mounting plate includes a pair of upstanding sidewalls extending from the opposite sides of the mounting plate.

13. The pass-through connector according to claim 12, wherein the mounting plate and each of the first and second extended portions are made from an electrically conductive material, wherein an electrical path is established between the first and second extended portions.

14. The pass-through connector according to claim 13, wherein the mounting plate includes at least one retaining clip affixed to a lower surface of the mounting plate, wherein the at least one retaining clip is adapted to support a plurality of cables being carried by the cable management system over a wider area in order to reduce a height of the plurality of cables.

15. The pass-through connector according to claim 14, wherein each retaining clip includes a first leg which is affixed to the lower surface of the mounting plate and a second leg which is spaced a distance from the lower surface of the mounting plate in order to define a space through which cables can be fed into the retaining clips.

16. A method of installing a pass-through connector for a cable management system on a barrier, the method comprising the steps of:
providing a pass-through connector including a pass-through body portion configured and adapted to support the run of cables through an opening formed in the barrier, and an electrical ground bond conductor secured to the pass-through body portion;
electrically connecting the pass-through connector to first and second portions of a cable management system.

17. The method according to claim 16, wherein the pass-through connector includes a tubular body having a proximal end and a distal end, the tubular body defining a lumen therethrough, and the ground bond conductor having a first and a second extended portion extending axially from a respective proximal and distal end of the tubular body.

18. The method according to claim 17, wherein the electrical conduit includes a shaft portion electrically interconnecting the first and second extended portions thereof.

19. The method according to claim 18, further comprising the step of:
securing the pass-through connector to the barrier with a fire stop collar assembly, the fire stop collar assembly being configured and adapted to surround the tubular body at least on one side of the barrier and to prevent the passage of fire through the barrier between a gap formed in the barrier for passage of the tubular body and an outer surface of the tubular body.

20. The method according to claim 19, further comprising the step of:
introducing an intumescing substance into the gap, the intumescing substance expanding upon an exposure to elevated temperatures to thereby seal the gap between the barrier and the tubular body.

21. The method according to claim 17, wherein the pass-through body portion is configured and adapted to be disposed in a gap between an upper and a lower barrier, the method further comprising the step of:
mounting the pass-through body portion to an opening formed in the barrier with a mounting plate configured and adapted to be secured to the barrier.
